(19) United States
(12) Patent Application Publication
(10) Pub. No.: US 2021/0146724 A1
(43) Pub. Date: May 20, 2021

(54) WHEEL FOR A MOTOR VEHICLE

(71) Applicant: AUDI AG, Ingolstadt (DE)

(72) Inventors: Bastian SCHEURICH, Lenting (DE); Wolfgang SCHMID, Freising (DE); Oliver SCHMIDT, Geisenfeld (DE); Andreas UNGER, Gaimersheim (DE); Kay-Uwe HENNING, Dachau (DE)

(73) Assignee: AUDI AG, Ingolstadt (DE)

(21) Appl. No.: 16/965,394

(22) PCT Filed: Dec. 21, 2018
(86) PCT No.: PCT/EP2018/086761

§ 371 Date: Jul. 28, 2020

(30) Foreign Application Priority Data
Feb. 8, 2018 (DE) 10 2018 202 003.5

(51) Int. Cl. B60C 5/22; B60C 19/00

(52) U.S. Cl. CPC B60C 5/22; B60C 2200/10; B60C 19/002

(57) ABSTRACT

Wheel for a motor vehicle, including a rim and an air-filled tire mounted thereon, wherein, in the interior of the wheel, a material adsorbing molecules contained in the air is provided.

The invention relates to a wheel for a motor vehicle, comprising a rim and an air-filled tire mounted thereon.

Today's motor vehicle tires must offer, on the one hand, as low as possible a rolling resistance; at the same time they should have a high load capacity and good driving dynamics, and offer a pleasant driving comfort in terms of spring properties or damping properties. In particular, the spring stiffness has a very great influence on the driving comfort. Here, the vehicle tire itself lies in between the conflicting priorities of the above-mentioned properties, since the improvement of one property sometimes leads to a deterioration of the other.

In particular, the air pressure in the wheel or in the tire is subject to this conflict of objectives. The tire, in addition to its design-related stiffness, contributes to the enclosed air volume according to the principle of volume suspension. Neglecting the design-related stiffness of the tire, it can be simply assumed that the spring stiffness of the system is calculated as follows:

$$c = \frac{n * p * {A}^{2}}{V}$$

with:

n=polytropic exponents

V=system volume

p=system pressure

A=effective area

The spring stiffness has, as mentioned, a great influence on the driving comfort. If the spring stiffness can be reduced, the system becomes “smoother,” the amplitude of the tire acceleration decreases, the natural frequency can be reduced. This leads to a significant improvement in the sense of comfort, both subjectively and objectively.

From the above equation, it follows that a reduction of the air pressure reduces the spring stiffness. However, lowering the air pressure also entails a decrease in the load capacity, and the rolling resistance and the driving dynamic properties of the tire or of the wheel also deteriorate. Increasing the volume of air at equal pressure is usually not possible. If the wheel width is increased, the rolling resistance deteriorates; possible space limitations prevent an increase in the wheel circumference.

The underlying problem of the invention therefore is to specify a wheel which has been improved in that regard.

In order to solve this problem, in a wheel of the type mentioned at the outset, it is provided according to the invention that, in the interior of the wheel, a material absorbing molecules contained in the air is provided.

The invention is based on the consideration of introducing a material absorbing molecules contained air into the interior of the wheel, resulting in a “virtual” increase in the volume of the air with the same existing installation space or volume of space. The adsorption material, also referred to as adsorbent, binds large amounts of free molecules in the air. The air consists primarily of nitrogen, oxygen and carbon dioxide, wherein nitrogen represents the largest portion, followed by oxygen and carbon dioxide. The adsorbing material, due to its very large specific surface area, is then capable of adsorbing, that is to say “storing,” some of these types of molecules or all these types of molecules. In this way, it is possible to increase the volume of air in the tire at constant outer contour and constant internal pressure. In fact, in this manner, more air can be introduced into the tire without any changes in geometry or pressure.

As can be seen from the above-mentioned equation, increasing the volume, that is to say the volume of air in the interior of the wheel, leads to a reduction of the spring stiffness of the tire or of the wheel. This results in an improvement of the driving comfort or the comfort properties of the tire or of the wheel, resulting from the fact that, on the one hand, a shift of the natural frequency is possible, and, on the other hand, a reduction of the amplification factor, which indicates how a disturbance introduced via the wheel onto or into the vehicle is transmitted, can be achieved. The lower the spring stiffness is, the lower the amplification factor is. This means that, due to the adsorption-related increase in the volume of the air, an improvement of the driving comfort can be achieved while at the same time the tire contour and the air pressure remain unaffected. As a result, driving dynamics variables can be set differently from one another.

At the same time, a larger volume of air also means a higher load capacity of the tire. In particular, energy storage devices such as batteries are used more and more in vehicles, wherein the batteries are heavy components. As a result the total weight of the vehicle increases. A larger volume of air in the tire can offer the consequently required higher load capacity of the tire.

As such an adsorbing material or adsorbent, activated charcoal is preferably used. Activated charcoal is porous carbon with a very large specific surface area. It consists predominantly of carbon, usually more than 90%, and it has a highly porous structure with open pores, wherein, depending on the pore size distribution, the specific surface area is 300-2000 m²/g activated charcoal. The pore size ranges from submicropores having a pore size of less than 0.4 nm to micropores (0.1-0.2 nm) and mesopores (2-50 nm) to macropores (greater than 50 nm). Activated charcoal is a very strong adsorbent, since it adsorbs the molecules present in the air very well, and, due to the extremely high surface area, it can store a large volume of air.

In addition to activated charcoal, activated coke, which is also carbon-based and which has a slightly smaller specific surface area, zeolite or a molecular sieve, for example, a carbon molecular sieve, can also be used. Any adsorptive material capable of adsorbing the molecules present in the air and having a sufficiently large specific surface area is suitable.

The material itself is preferably arranged fixed in position, so that it cannot move during the movement of the wheel.

According to an advantageous design, the material is arranged for this purpose on the rim, since the rim, unlike the tire, does not undergo deformation during travel. Particularly advantageously, the material is arranged around the rim well; here, a symmetric distribution is possible in a simple way, so that no imbalance is generated by the introduction of the material.

On the one hand, the material itself can be present as loose bulk material which is fixed in a corresponding holding means. For example, the activated charcoal can be in the form of pellets or granulate which is accommodated in a corresponding holding means. Alternatively, the material can also be present in pressed form, thus in a defined shape predetermined by a pressing process.

If loose bulk material is used, then, advantageously, either a holding means which is permeable to air and flexible is used, or a housing-like, stable and perforated holding means is used. As a holding means which is permeable to air and flexible, a woven or knitted fabric, for example, a woven filter medium or the like, can be used, in which the bulk material is held or sewn. It is also conceivable to design the holding means, for example, in the manner of a hose, a small bag or pouch and fill it with the bulk material.

If a stable holding means is used, said holding means can be made of plastic, for example, and be designed in the shape of a ring, preferably in multiple parts, so that it can be arranged such that it can be assembled like a housing and in the shape of a ring around the rim well. The perforation, in terms of diameter, is naturally formed in such a manner that the perforation openings are smaller in diameter than the bulk material.

For fixing, the holding means is preferably glued to the rim or the rim well, so that a secure hold is present and there is no risk of detachment even at very high wheel rotational speeds.

If a pressed material is used, then it is preferably designed in accordance with the shape of the section of the rim on which it is to be arranged. If the material is applied, for example, to the rim well, then the pressed material can be designed in the shape of a semicircle or a half-shell, so that two such parts are assembled to form a ring. This pressed material too is preferably glued to the rim, in particular to the rim well.

In addition to the wheel itself, the invention further relates to a motor vehicle comprising multiple wheels of the described type. The motor vehicle can be, for example, a two-wheeled vehicle, that is to say a motorcycle, or a four-wheeled automobile.

Additional advantages and details of the invention result from the embodiment examples described below and in reference to the drawings. In the drawings:

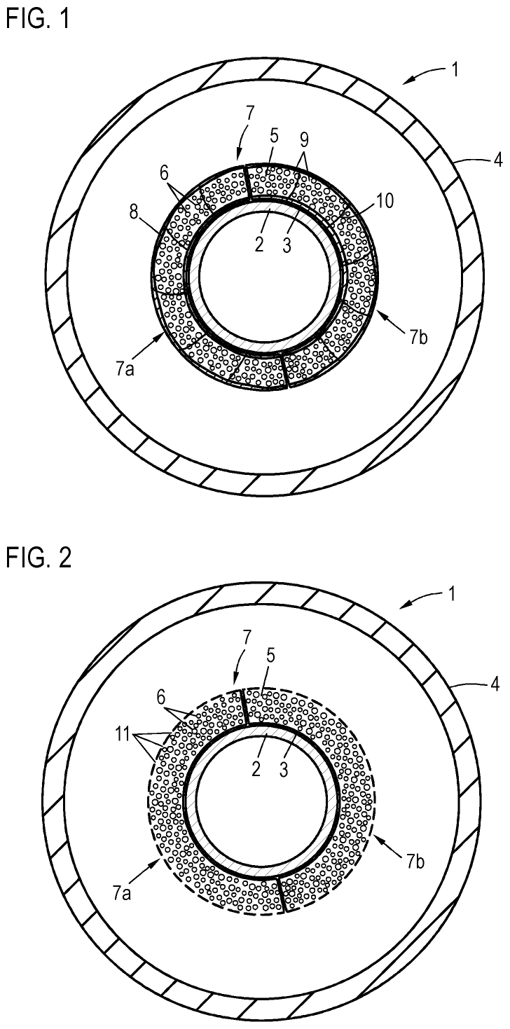

FIG. 1 shows a wheel according to the invention of a first embodiment,

FIG. 2 shows a wheel according to the invention of a second embodiment, and

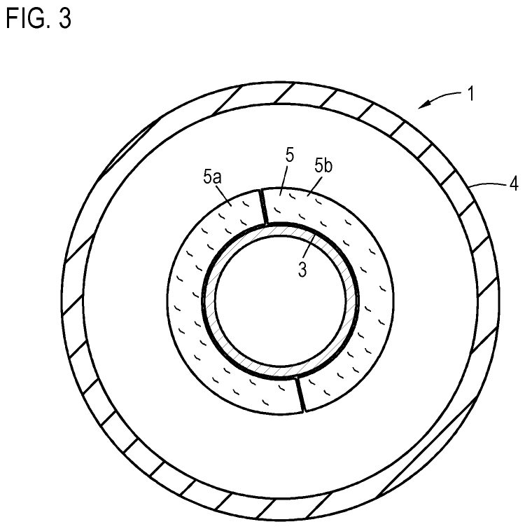

FIG. 3 shows a wheel according to the invention of a third embodiment.

FIG. 1 shows a wheel 1 according to the invention, suitable for a motor vehicle such as a motorcycle or an automobile, in a partial cut view. It comprises a rim 2 with a rim well 3 as well as a tire 4 mounted on the rim. The interior of the tire 4 is filled with air.

In the interior of the wheel 1 or of the tire 4, a material 5 adsorbing molecules contained in the air is provided, which is, for example, activated charcoal. The material 5 here is in the form of a loose bulk material, for example, in the form of a granulate 6 or larger pellets. As can be seen, the material 5 is arranged around the rim well 2 and densely packed. In order to fix it in this position, a holding means 7 is provided, consisting here of an air-permeable and flexible cloth or woven fabric 8, for example, a woven filter medium, which is substantially hose-shaped and appropriately filled with the material 5. The material 5 can be appropriately sewn into the cloth or woven fabric 8, for the purpose of which corresponding pocket-like recesses 9 are formed by corresponding tucks 10 or the like. In the example shown, two such filled holding means 7a, 7b, each extending 180 degrees, are represented, which complement each other to form an annular shape which surrounds the entire rim well. More than two such holding means 7 are also conceivable. The fixing occurs preferably by gluing on the rim well.

By means of the introduced material 5, a clearly larger volume of air can be introduced into the tires 4, that is to say can be stored in the interior, since the material 5, due to its extremely large surface area, adsorbs the molecules contained in the air, so that in a manner of speaking a virtual volume increase can be achieved. In this manner, due to a resulting reduction of the spring stiffness, the driving comfort can be improved without entailing a deterioration of the rolling resistance, the load capacity and the driving dynamics.

FIG. 2 shows a second embodiment example of a wheel 1 according to the invention, wherein identical reference numerals are used for identical components. Here too, a material 5 is provided on the rim well 3, for example, again an activated charcoal in the form of a granulate 6. The latter in turn is accommodated in a corresponding holding means 7, wherein the holding means 7, here a stable, housing-like holding means, is provided with a plurality of perforation openings 11, through which the air molecules can penetrate into the interior. Again, two holding means 7a, 7b are shown, each running circumferentially through 180 degrees and connected to form an annular shape. These holding means 7a, 7b, that is to say the half-shell housings, are made, for example, of plastic. They too are preferably secured via an adhesive connection on the rim well.

Finally, FIG. 3 shows a wheel 1 according to the invention, in which the material 5 in pressed form, that is to say in stable form, is applied, again preferably glued, to the rim well 3. Here too, two halves are provided, namely the sections 5a and 5b which in turn complement each other to form an annular shape. The respective pressed bodies are thus adapted to the shape of the component on which they are arranged. Thus, in this case, the shape of the rim well 3. Special holding means are not necessary here due to the pressing of the material 5, which is again activated charcoal, for example.

1-11. (canceled)

12. A wheel for a vehicle, comprising:
a rim and an air-filled tire mounted thereon, wherein, in the interior of the wheel, a material adsorbing molecules contained in the air is provided.

13. The wheel according to claim 12, wherein the material is at least one of activated charcoal, activated coke, zeolite, or a molecular sieve.

14. The wheel according to claim 13, wherein the material is arranged fixed in position.

15. The wheel according to claim 14, wherein the material is arranged on the rim.

16. The wheel according to claim 15, wherein the material is arranged around the rim well.

17. The wheel according to claim 12, wherein the material is present as loose bulk material which is fixed in a holding means or as pressed material.

18. The wheel according to claim 17, wherein the holding means is permeable to air and flexible.

19. The wheel according to claim 17, wherein the holding means has a housing-like, stable, and perforated design.

20. The wheel according to claim 14, wherein the pressed material is shaped in accordance with the shape of the section of the rim on which it is to be arranged.

21. The wheel according to any one of claim 18, wherein the holding means or the pressed material is glued to the rim, in particular to the rim well.

22. The wheel according to claim 13, wherein the material is present as loose bulk material which is fixed in a holding means or as pressed material.

23. The wheel according to claim 14, wherein the material is present as loose bulk material which is fixed in a holding means or as pressed material.

24. The wheel according to claim 15, wherein the material is present as loose bulk material which is fixed in a holding means or as pressed material.

25. The wheel according to claim 16, wherein the material is present as loose bulk material which is fixed in a holding means or as pressed material.

26. The wheel according to claim 15, wherein the pressed material is shaped in accordance with the shape of the section of the rim on which it is to be arranged.

27. The wheel according to claim 17, wherein the pressed material is shaped in accordance with the shape of the section of the rim on which it is to be arranged.

28. The wheel according to any one of claim 19, wherein the holding means or the pressed material is glued to the rim, in particular to the rim well.

29. The wheel according to any one of claim 20, wherein the holding means or the pressed material is glued to the rim, in particular to the rim well.
